(19) United States
(12) Patent Application Publication
(10) Pub. No.: US 2004/0121040 A1
(43) Pub. Date: Jun. 24, 2004

(54) Method of producing a xanthohumol-concentrated hop extracted and use thereof

(75) Inventors: Adrian Forster, Wolnzach (DE); Josef Schulmeyr, Wolnzach (DE); Roland Schmidt, Wolnzach (DE); Karin Simon, Pfaffenhofen (DE); Martin Ketterer, Wolnzach (DE); Birgit Forchhammer, Neustadt (DE); Stefan Geyer, Wolnzach (DE); Manfred Gehrig, Wolnzach (DE)

Correspondence Address: BROWDY AND NEIMARK, P.L.L.C., 624 NINTH STREET, NW, SUITE 300, WASHINGTON, DC, 20001-5303, US

(73) Assignee: NATECO2 GMBH & CO. KG, Wolnzach (DE)

(21) Appl. No.: 10/724,237

(22) Filed: Dec. 1, 2003

(30) Foreign Application Priority Data
Nov. 30, 2002 (DE) 102 56 031.5

(51) Int. Cl. C12G 1/00

(52) U.S. Cl. 426/15

(57) ABSTRACT

In a method of producing a xanthohumol-concentrated hop extract, the xanthohumol-containing hop extract is extracted from a xanthohumol-containing hop raw material by highly compressed CO₂ as a solvent at pressures above 500 bar and temperatures above 60° C.

### BACKGROUND OF THE INVENTION

1. Field of the Invention

The invention relates to a method of producing a xanthohumol-concentrated hop extract as well as the use of such an extract.

2. Background Art

The background of the invention will be explained at the outset by a short explanation of the basic idea of the invention in terms of dietary physiology. Hop is an indispensable raw material in beer preparation. It contains three essential groups of agents in dried form. Hop resins confer the characteristic bitterness to beer. With its variety of flavor components, hop oil confers a typical flavor to the beer. Hop tannins comprise numerous polyphenols such as flavanols, proanthocyanides, flavanoids of the kaempherol and quercetin, benzoic acids and cinnamic acid. The evaluation thereof is not homogeneous as regards beer quality.

Most hop polyphenols are excellently soluble in hot water. They are anti-oxidative and contribute to the taste. However, they tend to forming cloudy protein complexes in finished beer during storage so that the estimation thereof varies. Lots of breweries deliberately do without the addition of hop polyphenols in order to improve the shelf life of their beer and to reduce the susceptibility thereof to clouding.

Tannin-free hop products are obtained by the extraction of hop with solvents. In doing so, fluid and in particular supercritical CO₂ has proved successful worldwide; it will dissolve any bittering and flavoring substances, but no polyphenols. Extracts produced by using ethanol are of minor importance.

Hop contains a very specific polyphenol, namely xanthohumol, a flavanoid of the chalcone group. Worldwide examinations over the last years have shown that xanthohumol possesses highly interesting anti-cancerigenous properties. Research has meanwhile been extended to live cells. There is a hope of using xanthohumol as a cancer-chemopreventive substance in the future, which shows there is a demand for concentrating xanthohumol from hop.

For a polyphenol, the solubility of xanthohumol is extraordinary. It is so nonpolar that it is hardly soluble in hot water, but excellently soluble in alcohol or alcohol-water mixes. On the other hand, nonpolar solvents such as hexane are not able to dissolve xanthohumol. Depending on the grade, dried hop contains a quantity of 0.2 to 1.0 percent by weight of xanthohumol.

During beer preparation, xanthohumol transforms into isoxanthohumol. Isoxanthohumol possesses clearly less anti-cancerigenous properties. Moreover, most of the xanthohumol and of the isoxanthohumol is eliminated by yest, cloud and filtration during beer preparation. Commercial beer is not going to be an especially appropriate means of utilizing the cancer-inhibiting potential of xanthohumol. What is absolutely desirable would be a suitable, xanthohumol-concentrated extract that can be added for example to the finished beer or other kinds of food or used by itself as a chemo-preventive preparation.

Presently, there are two prior art solutions. DE 199 39 350 A1 describes a method of producing a xanthohumol-enriched hop extract, with combinations of water and ethanol being used preferably in two steps of extraction. 5 to 15 percent by weight of xanthohumol are specified as being typical. Apart from xanthohumol, other hop tannins are extracted as well, having the known clouding tendencies.

Another publication describes how any bitterings and flavorings that are soluble with supercritical CO₂ are extracted from a commercial xanthohumol-containing hop extract obtained by the aid of ethanol after the addition of a solid substrate. What is retained after this purification process is a mix of the substrate, various resins that are not soluble in CO₂ and xanthohumol of only a weak concentration of 2 percent by weight as against hop.

### SUMMARY OF THE INVENTION

It is an object of the invention to specify a method of producing a xanthohumol-concentrated hop extract, in which to obtain high concentration rates without organic solvents or multistage extraction processes relating to the xanthohumol.

A fundamental solution of this object is specified by the invention, according to which the xanthohumol-containing hop extract is extracted from a xanthohumol-containing hop raw material by highly compressed CO₂ as a solvent at pressures above 500 bar and temperatures above 60° C.

Proceeding from presently available prior art knowledge, the method according to the invention treads on a path that deviates entirely from the prior art. In literature, nonpolar, supercritical CO₂ has always been described as being totally inept for xanthohumol extraction. All the more surprisingly, supercritical CO₂, when used in a so far totally unusual combination of pressure and temperature upon extraction, will be able to dissolve xanthohumol. The resulting contents of xanthohumol in the extracts obtained are stupefyingly high, this also implying a total extract of resin and flavor substances that are relevant to brewing and xanthohumol.

All the patents and literature so far available consider and describe the extraction properties of supercritical CO₂ at pressures up to 500 bar. In this context, German patent 21 27 618 (production of hop extracts) is cited by way of example. Since no improved extraction properties were found at pressures above 300 to 500 bar, those skilled in the art assumed that no additional effect could be accomplished by further augmented extraction pressures. Improved extraction properties of supercritical CO₂ were assumed to be due only to increased temperature, as known from German patent 33 46 776. Thus, however, xanthohumol could not be dissolved.

In the development of the invention it has however been found that using CO₂ at pressures above the 300 to 500 bar so far described will have unexpected results. For instance, extraction pressures of approximately 600 to 1000 bar have proved suitable to dissolve xanthohumol. If for example flavoring and bittering substances are extracted from the hop at conventional supercritical conditions of approximately 200 to 300 bar and 40 to 60° C., and if the residue is subjected to another CO₂ extraction at between 600 to 1000 bar and 70 to 90° C., a hop extract is obtained, ranging from 10 to 20 percent by weight of xanthohumol contents. By clever selection of separating conditions, this extract can be taken in dried form from the separator. The hop extract thus obtained is particularly rich in xanthohumol, further containing chlorophyll and moderately bittering hop resin components. It is free from undesirable clouding polyphenols such as flavanols and proanthocyanidines. It does not contain any protein, carbon hydrates and in particular any undesired salts such as for instance nitrate. It needs no further processing such as drying and does not contain any hop impurities.

Pressures higher than 1000 bar might work as well. They could not be tested for technical reasons. The xanthohumol-concentrated hop extract can also be produced without the utilization of extraction promoters in the CO₂. It is known from various publications that supercritical CO₂, by the addition of entrainers of predominantly more polar character, such as water or alcohols, changes its extraction properties so that more polar substances can also be dissolved from a solid. For instance water is used as an extraction promoter for eliminating caffeine in coffee or tea by supercritical CO₂ without also non-selectively removing positive flavor components. Using entrainers therefore suggested itself for dissolveing xanthohumol from hop by the known and usual supercritical CO₂. However, physiologically safe promoters such as water, alcohols such as ethanol, esters such as ethylacetate, or ketones such as acetone, could not attain any drastic increase in solubility of xanthohumol.

In a range of pressure above 500 bar, the use of entrainers is conceivable, but not indispensable. This has the advantage of no solvent residues having to be accepted in the hop extract. Surprisingly it has also been found that all sorts of hop pellets as well as residues of extraction by conventional subcritical and supercritical CO₂-methods may serve as an initial product for xanthohumol extraction. Even hop pellets that are comparatively very dry or CO₂-pre-extracted hop pellets of a water content of 3 to approximately 15 percent by weight are suitable.

The invention further relates to the use of a xanthohumol-concentrated hop extract, produced as outlined above, as an admixture to solid, pasty or liquid food. Admixture in a dry, pourable form is suitable in particular for being added to solid food. Preferably, the hop extract in its dry, pourable form may be completely dissolved in an appropriate organic solvent and added to beverage. This may take place in the form of continuous addition during a pumping or conveying process.

Ethanol is preferably used as a solvent, with concentrations of up to 20 percent by weight of the xanthohumol-concentrated extract being added to the solution.

Further features, details and advantages of the invention will become apparent from the ensuing description of several examples.

### DESCRIPTION OF EXAMPLES

### Example 1

10 kg of hop pellets are extracted with CO₂ at usual supercritical (CO₂) conditions at 250 bar and 50° C. In doing so, bitterings and flavorings that are valuable in brewing are dissolved. The extraction residue is extracted with CO₂ at 800 bar for three hours on the same or a separate installation. The extract obtained upon subsequent extraction is retained in a separator and withdrawn after termination of the extraction. It contains 5 to 20 percent by weight xanthohumol, depending on the raw material. The extract obtained is solid and can easily be ground into powder.

### Example 2

10 kg of hop residues, pre-extracted at usual supercritical CO₂ conditions, are extracted with CO₂ at 800 bar and 80° C. for three hours. The richly green extract gained is collected at 65 bar and 50° C. in a separating vessel. Xanthohumol contents amount to 5 to 20 percent by weight, depending on the raw material.

### Example 3

The two steps of extraction can be combined by having CO₂ pass through a bed of hop pellets at 800 bar and 80° C. right from the beginning. By two-stage separation, the xanthohumol-concentrated extract can be separated at 250 bar and 60° C.; the hop extract that is relevant to brewing is obtained at 65 bar and approximately 50° C.

### Example 4

Special efficiency is obtained by subsequent extraction of hop pellets of the type Taurus that have been extracted with supercritical CO₂ at conventional conditions. 10 kg of these pellets are extracted with CO₂ at 800 bar and 80° C. The dissolved ingredients are separated at 200 bar and 60° C. in a first step. This extract is especially selectively concentrated in xanthohumol, containing up to 40 percent by weight of xanthohumol. In a second step of separation, an extract mix separates at 65 bar and 50° C., containing only little xanthohumol.

What is claimed is:

1. A method of producing a xanthohumol-concentrated hop extract, wherein the xanthohumol-containing hop extract is extracted from a xanthohumol-containing hop raw material by highly compressed CO₂ as a solvent at pressures above 500 bar and at temperatures above 60° C.

2. A method according to claim 1, wherein extraction takes place at pressures between 600 and 1000 bar and at temperatures between 70 and 90° C.

3. A method according to claim 1, wherein hop pellets, pre-extracted with usual, supercritical CO₂, are used as hop raw material, the hop pellets being subjected to subsequent extraction with CO₂ at 600 to 1000 bar and at 60 to 90° C., after which dissolved ingredients are separated together with the xanthohumol-concentrated hop extract.

4. A method according to claim 3, wherein the subsequent extraction takes place at pressures of up to 900 bar and at 75 to 90° C.

5. A method according to claim 3, wherein separation takes place in a separating vessel at a pressure of up to 200 bar and a temperature of up to 90° C.

6. A method according to claim 5, wherein the separation takes place at a pressure of 60 to 70 bar and a temperature of 40 to 60° C.

7. A method according to claim 1, wherein hop pellets are used as a hop raw material, which are extracted at 600 to 900 bar to obtain a pre-extract, after which the xanthohumol-concentrated extract is separated from the pre-extract at pressures of 200 to 500 bar and temperatures of 40 to 90° C. in a first step, and an extract, usual for beer brewing, is separated at pressures of 60 to 80 bar and temperatures of 40 to 60° C. in a second step.

8. A method according to claim 1, wherein the xanthohumol-concentrated hop extract is gained in a separator as a stable powder that needs no drying and is free from additives.

9. Use of a xanthohumol-concentrated hop extract which is produced according to claim 1, wherein the xanthohumol-concentrated hop extract is used as an admixture to solid, pasty or liquid food.

10. Use of a xanthohumol-concentrated hop extract according to claim 9, wherein the xanthohumol-concentrated hop extract is admixed in a dry, pourable form.

11. Use of a xanthohumol-concentrated hop extract according to claim 9, wherein the xanthohumol-concentrated hop extract, in its dry, pourable form, is completely dissolved in an appropriate organic solvent and added to beverage.

12. Use of a xanthohumol-concentrated hop extract according to claim 11, wherein the xanthohumol-concentrated hop extract is added by way of continuous addition during one of a pumping and conveying process.

13. Use of a xanthohumol-concentrated hop extract according to claim 11, wherein ethanol is used as a solvent and concentrations of up to 20 percent by weight of the xanthohumol-concentrated hop extract are used in the solution.
